(19) United States
(12) Patent Application Publication
(10) Pub. No.: US 2014/0168134 A1
(43) Pub. Date: Jun. 19, 2014

(54) Videoconferencing Terminal

(71) Applicant: Alcatel-Lucent USA Inc, Murray Hill, NJ (US)

(72) Inventors: Cristian A. Bolle, Bridgewater, NJ (US); David A. Duque, Hillsborough, NJ (US); Roland Ryf, Holmdel, NJ (US)

(73) Assignee: Alcatel-Lucent USA Inc., Murray Hill, NJ (US)

(21) Appl. No.: 13/719,088

(22) Filed: Dec. 18, 2012

(51) Int. Cl. G06F 3/044

(52) U.S. Cl. CPC G06F 3/044
USPC 345/174

(57) ABSTRACT

A videoconferencing terminal comprising an actuator configured to move a plurality of arms relative to a substantially transparent substrate wherein at least one arm comprises capacitive sensors. Upon touching said substantially transparent substrate at least one capacitive sensor detects a change in an electrostatic field.

### TECHNICAL FIELD

The disclosure is directed, in general, to a videoconferencing terminal.

### BACKGROUND

This section introduces aspects that may be helpful in facilitating a better understanding of the disclosure. Accordingly, the statements of this section are to be read in this light and are not to be understood as admissions about what is in the prior art or what is not in the prior art.

Communications via computer networks frequently involve far more than transmitting text. Computer networks, such as the Internet, can also be used for audio communications and visual communications. Still images and video are examples of visual data that may be transmitted over such networks.

One or more cameras may be coupled to a personal computer (PC) to provide visual communication. The camera or cameras can then be used to transmit real-time visual information, such as video, over a computer network. Dual transmission can be used to allow audio transmission with the video information. Whether in one-to-one communication sessions or through videoconferencing with multiple participants, participants can communicate via audio and video in real time over a computer network (i.e., voice-video communications). Typically the visual images transmitted during voice-video communication sessions depend on the placement of the camera or cameras.

### SUMMARY

In one aspect there is provided an apparatus. In one embodiment, the apparatus includes an actuator configured to move an arm relative to a substantially transparent substrate, said arm comprising a capacitive sensor configured for detecting a change in an electrostatic field in response to a touch effected on said substantially transparent substrate.

In another aspect there is provided a method. In one embodiment, the method includes:
moving an arm relative to a substantially transparent substrate;
touching said substantially transparent substrate; and
detecting by a capacitive sensor on said arm, a change in an electrostatic field caused by said touch.

### BRIEF DESCRIPTION OF THE DRAWINGS

Reference is now made to the following descriptions taken in conjunction with the accompanying drawings, in which:

FIG. 1 is a schematic block diagram of an embodiment of a videoconferencing infrastructure within which a videoconferencing terminal constructed according to the principles of the disclosure may operate;

FIG. 2A and FIG. 2B are exemplary schematic representations of an embodiment of a videoconferencing terminal, in which the principles of the disclosure may be implemented;

FIG. 3 is an exemplary schematic representation of certain elements comprised in an embodiment of a videoconferencing terminal constructed according to the principles of the disclosure; and

FIG. 4 is an exemplary schematic representation of an embodiment including certain elements which may be incorporated in a videoconferencing terminal constructed according to the principles of the disclosure.

### DETAILED DESCRIPTION

As noted above, an apparatus is disclosed including a capacitive sensor configured for detecting a change in an electrostatic field in response to a touch effected on a substantially transparent substrate. In some embodiments the touch is effected by a touch element. In some embodiments the capacitive sensor is configured to identify a position touched by the touch element. In some embodiments the touch element is a human finger or a conductive material configured for use in capacitive sensing. In some embodiments the capacitive sensor comprises an electrode configured to measure capacity, the substantially transparent substrate is a non-conductive region and the touch element is a second electrode for such capacitor.

In some embodiments of the apparatus, at least a second arm is configured to operate as a display substrate for providing persistence of vision effect. In some embodiments, at least one arm is configured to operate as a display substrate for providing persistence of vision effect and comprises a capacitive sensor configured for detecting a change in an electrostatic field in response to a touch effected on said substantially transparent substrate.

In some embodiments, the capacitive sensor is configured to scan an area on the substantially transparent substrate, the scanning being achievable upon the movement of the arm relative to the transparent substrate.

In some embodiments the apparatus further comprises an optical source and an optical detector pair configured for determining a speed of movement of the arm. In some embodiments the optical source is installed on an arm of the apparatus and the optical detector is installed at a position within a scan area of the optical source said detector being configured to detect an optical signal generated by the optical source.

In some embodiments the optical source and the optical detector are configured for transmitting data corresponding to detection of a touch to further stages of the apparatus. In some embodiments the optical source and the optical detector are configured to operate using infrared signals.

In some embodiments a touch interface area being less than the entire surface area of the substantially transparent substrate is designated for touching to cause the change in an electrostatic field in the apparatus.

In some embodiments further arms are configured for respectively displaying red, green and blue image data to enable production of images in color.

As noted above, a method is also disclosed herein that includes detecting by a capacitive sensor on an arm, a change in an electrostatic field caused by a touch. In some embodiments the capacitive sensor identifies a position touched by the touch element. In some embodiments at least a second arm provides persistence of vision effect.

In some embodiments the capacitive sensor scans an area on the substantially transparent substrate by moving the arm relative to the transparent substrate.

In some embodiments the method further comprises determining a speed of movement of the arm using an optical source and optical detector. In some embodiments the optical detector transmits data corresponding to detection of a touch to further stages of the apparatus.

In some embodiments the method comprises determining a position of the touch on the substantially transparent substrate using data corresponding to the speed of movement of the arm and the location of the capacitive sensor on the arm.

The disclosed apparatus and method can be used in videoconferencing. In videoconferencing applications, videoconferencing terminals are used for example between two users that wish to establish videoconferencing, each user typically using a respective videoconferencing terminal (or apparatus).

Herein, videoconferencing data may comprise visual communication data, audio communication, or a combination thereof.

In a videoconferencing terminal, establishing eye contact between the participants greatly enhances the feeling of intimacy. Unfortunately, the display and camera in many conventional videoconferencing terminals are not aligned. The resulting parallax prevents eye contact from being established between participants of the videoconference.

US Patent application publication number 2011/0149012 describes a videoconferencing terminal with a persistence of vision display and a method of operation thereof to maintain eye contact, which is incorporated herein by reference in its entirety.

The videoconferencing terminals can display an image by employing an array of electronic light sources (e.g., red, green and blue light-emitting diodes (LEDs)) spun at a speed high enough such that the human eye cannot follow the motion and will see a continuous image. If the electronic light sources are modulated in a synchronized way at even higher speed, an image can be displayed. For example, the electronic light sources may be rotated at a speed for an image repetition or refreshment of 60 Hz and modulated at a speed of 1 MHz. A camera can then be located behind the electronic light sources that allows a video conference participant to establish eye contact by looking through the front of the terminal to the camera instead of, for example, looking at a camera mounted on the top or side of the terminal.

A display substrate is used to provide a persistence of vision display. The shape or type of display substrate may vary and may be based on the geometry of the viewing area of a particular videoconferencing terminal. For example, the display substrate includes a wheel with one or more vanes (or arms) extending from a center. The wheel is configured to carry on the front of each arm a necessary array of electronic light sources to accurately display an image while the structure is rotated by an actuator (e.g., a motor that may be centrally mounted with respect to a viewing area). A suitable image repetition rate may be used to provide the persistence of vision effect. The rotation speed of the arms) can be determined according to each specific application.

Any additional electronics needed to drive the electronic light sources can be mounted on the back of each arm and out of sight from a local participant. Power to drive the electronic light sources may be transferred over the shaft of the motor by a set of brushes or coaxial transformer.

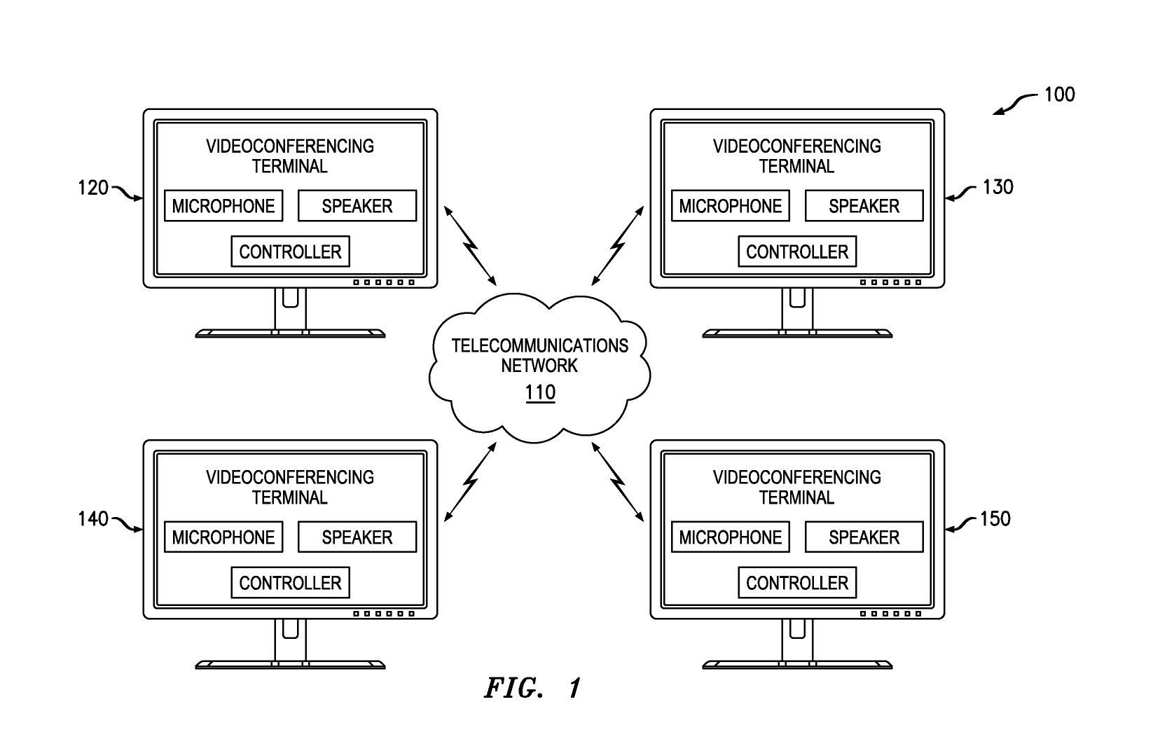

FIG. 1 is a schematic block diagram of one example of a videoconferencing infrastructure within which a videoconferencing terminal constructed according to the principles of the disclosure may operate. This embodiment of the videoconferencing infrastructure 100 is centered about a telecommunications network 110 that is employed to interconnect two or more videoconferencing terminals 120, 130, 140, 150, for communication of video signals or information, and perhaps also audio signals or information, therebetween. An alternative embodiment of the videoconferencing infrastructure 100 is centered about a computer network, such as the Internet. Still another embodiment of the videoconferencing infrastructure 100 involves a connection between two or more videoconferencing terminals, e.g., connection of the videoconferencing terminals 120, 130, via a plain old telephone (POTS) network. As represented in the videoconferencing terminal 120, the videoconferencing terminals 120, 130, 140, 150, may include components typically included in a conventional videoconferencing terminal, such as, a microphone, a speaker and a controller. The microphone can be configured to generate an audio signal based on acoustic energy received thereby, and the speaker can be configured to generate acoustic energy based on an audio signal received thereby.

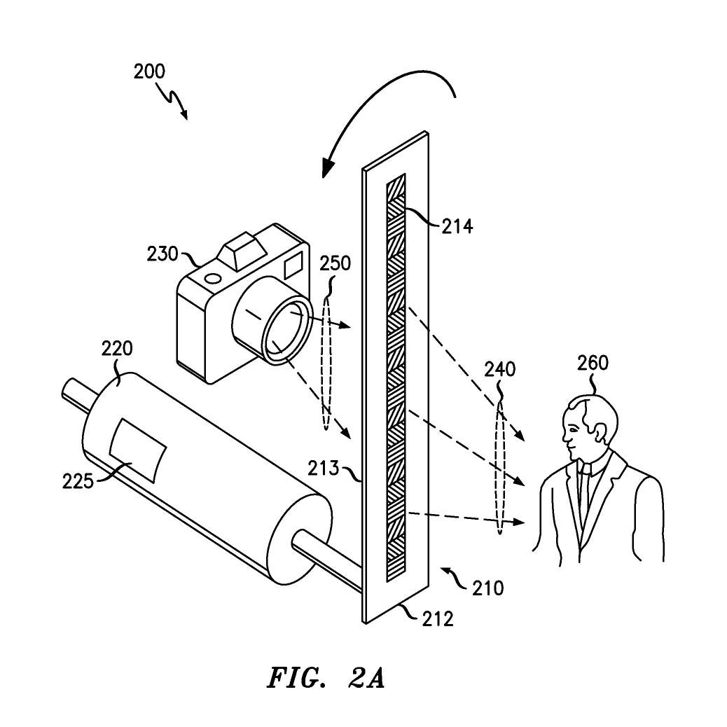

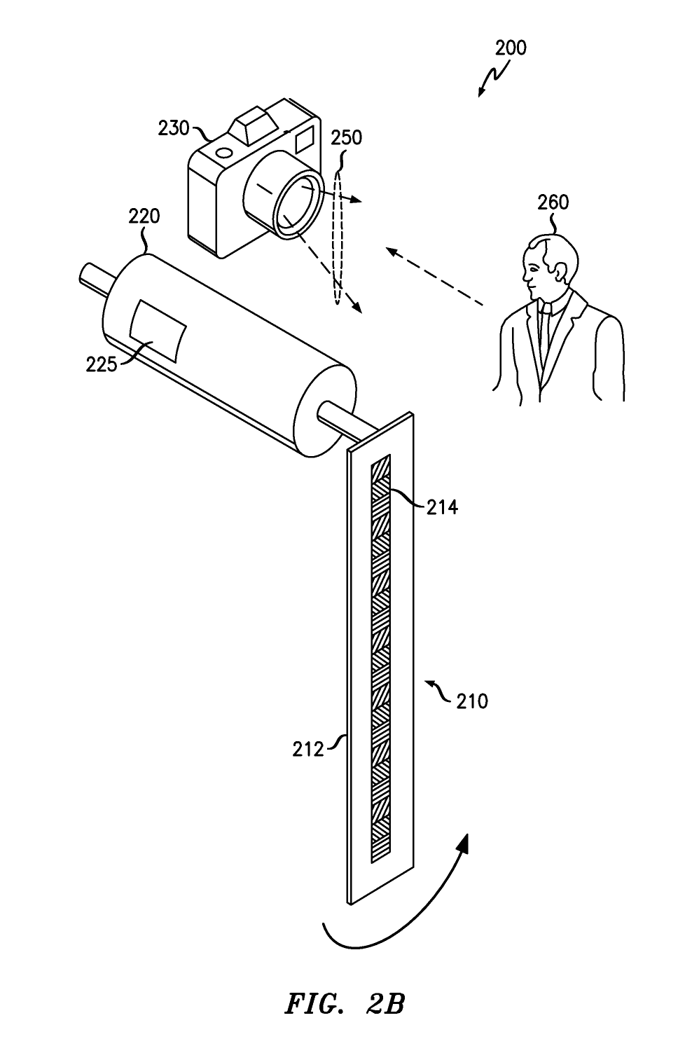

FIG. 2A and FIG. 2B are schematic views of an embodiment of a videoconferencing terminal 200, which may be used in the videoconferencing infrastructure of FIG. 1. The videoconferencing terminal 200 is configured to simultaneously capture a camera image from and provide a display image to a local videoconferencing participant 260. The videoconferencing terminal 200 includes an arm 210 configured to operate as a display substrate, an actuator 220 and a camera 230.

The arm 210 includes a substrate 212 having an array of electronic light sources 214 located thereon. The array 214 may be a single column array as illustrated or may include multiple columns. By controllably moving (e.g., rotating in this instance) the array of electronic light sources 214 over a viewing area 240, a persistence of vision display on the viewing area 240 is achieved. To that end, the number of rows of the array of electronic light sources 214 may be selected such that in operation an image generated by the electronic light sources substantially covers the viewing area 240. The viewing area 240 may coincide with a substantially transparent substrate that is placed on the viewing side of the videoconferencing terminal 200 (i.e., opposite side of the display substrate on the arm 210 from the camera 230). The display substrate on arm 210 occupies less than an entirety of the viewing area 240. Thus, the display substrate is smaller than the viewing area 240. Accordingly, persistence of vision is relied on to provide a display image for the videoconferencing terminal 200. The arm 210 (and thus the display substrate) may be caused to move (e.g. rotate) using an actuator 220.

The videoconferencing terminal 200 also includes electronic circuitry 213 coupled to the array of electronic light sources 214. The electronic circuitry 213 is configured to control the array of electronic light sources 214 to form a display image. The electronic circuitry 213 may be located behind the display substrate, i.e. on an opposing surface of the substrate 212 from the array of electronic light sources 214 as illustrated in FIG. 2A. The electronic circuitry 213 is configured to direct the operation of each of the electronic light sources of the array 214. The electronic circuitry 213 may be partially or totally incorporated in the substrate 212. In other embodiments, the electronic circuitry 213 for the electronic light sources 214 may be formed on a separate substrate from the substrate 212. The electronic circuitry 213 may include a matrix of thin film transistors (TFT) with each TFT driving and/or controlling a particular electronic light source of the array 214. The electronic circuitry 213 may include components typically employed in a conventional array-type active backplane. In one embodiment, the electronic circuitry 213 may operate similar to an active backplane employed in a conventional LED display. However other known display elements may likewise be used. Power to drive the electronic light sources 214 (and the electronic circuitry 213) may be transferred over a shaft of the actuator by a set of mechanical brushes or other known techniques.

In such videoconferencing terminals, in addition to the traditional human input interfaces like keyboards and pointing devices like a ‘mouse’, a ‘touch interface’ may be used where objects on a display are manipulated directly by touching on the display surface.

The above-referenced US Patent application publication number 2011/0149012 further discloses an embodiment of a human interface useable with the video conferencing terminal. According to this document, an array of photodetectors may be included on the arm that scans a substantially transparent substrate (e.g., a glass window) located in the front of the videoconferencing terminal. The photodetectors can detect the changes in the glass as a finger touches it. It will also be able to detect multiple fingers touching the glass at the same time.

In the above-referenced US Patent application publication number 2011/0149012, it is disclosed that the photodetectors may be infrared detectors.

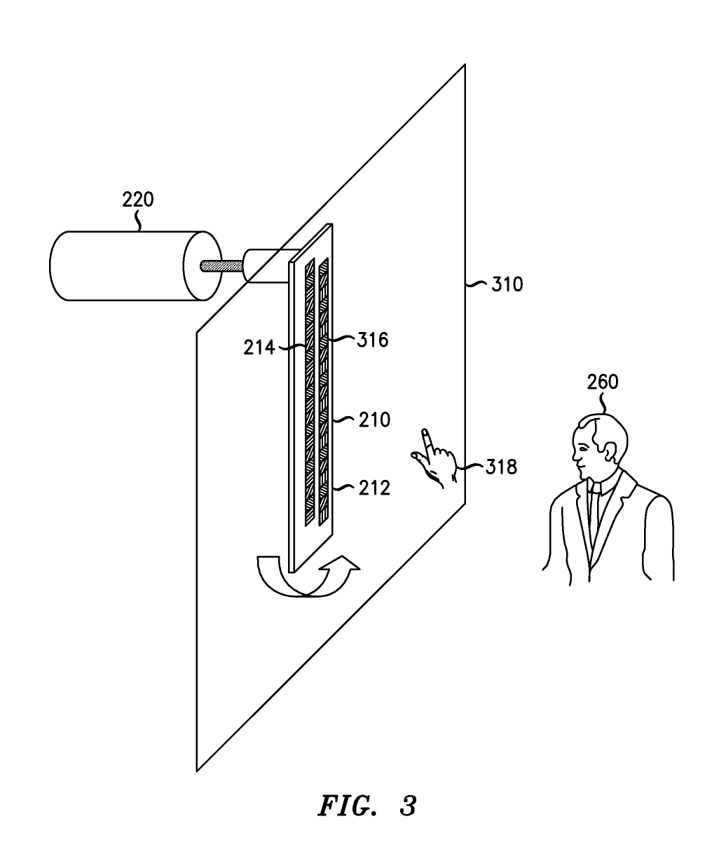

FIG. 3 is an exemplary schematic representation of certain elements comprised in an embodiment of a videoconferencing terminal constructed according to the principles of the disclosure. In FIG. 3, likes elements have been given like reference numerals as in FIGS. 2A and 2B.

The elements shown in FIG. 3 comprise an actuator 220 and an arm 210 configured to operate as display substrate including a substrate 212 having an array of light sources 214 as described with reference to FIGS. 2A and 2B. It is to be understood that the elements shown in FIG. 3 are components which may form part of a videoconferencing terminal similar to the terminal 200 of FIGS. 2A and 2B in which case, the videoconferencing terminal would include additional components, such as for example a camera, which are not shown in FIG. 3 for the sake of simplicity.

Additionally, FIG. 3 illustrates a substantially transparent substrate 310, such as a screen, and the display substrate of arm 210 includes an array of detectors 316 configured to detect the touching of the substantially transparent substrate 310 by a touch element 318, for example a human finger. The substantially transparent substrate 310 may be, for example, glass. In other embodiments, the substantially transparent substrate 310 may be another substrate that is transparent to visible light or is transparent to one or more frequency segments of the visible light spectrum.

In the context of the present disclosure, the term “substantially” when reference is made to the transparent substrate is to be understood in a broad sense in which said substrate is considered transparent as long as it allows the passage of sufficient light therethrough to and from the optical elements of the apparatus such as the camera and the images generated by the light sources; as well as allowing any other optical transmission between the front and the back sides of the substantially transparent substrate.

Differently from the disclosure of the above-referenced US Patent application publication number 2011/0149012 in which the array of detectors 316 configured to detect touching of the substantially transparent substrate are infrared photodetectors, according to the present disclosure, the detectors are capacitive touch interface elements comprised in one or more arms 210 of a videoconferencing terminal.

Therefore, if the substantially transparent substrate 310 is touched with a touch element 318, the array of capacitive sensors 316 can identify the position touched by the touch element(s). The array of capacitive sensors 316 may scan the substantially transparent substrate 310 when the display substrate is being moved by the actuator 220. The array of capacitive sensors 316 can therefore be used as a human interface. An electronic circuitry, not shown in FIG. 3 may be configured to direct the operation of the array of detectors 316.

The touch element 318 may be any suitable element for the intended use. For example the touch element 318 may be a human finger or it may be any conductive material configured for use in capacitive sensing.

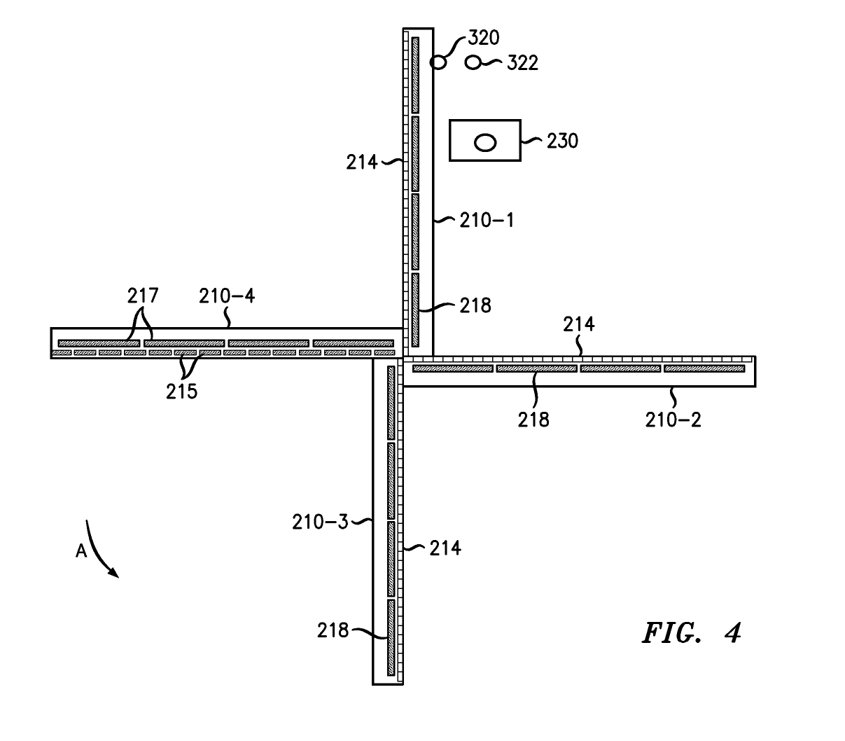

FIG. 4 is an exemplary schematic representation of an embodiment including certain elements which may be incorporated in a videoconferencing terminal constructed according to the principles of the disclosure.

In FIG. 4 like elements have been given like reference numerals as those of FIG. 3. Here also it is to be understood that the elements shown in FIG. 4 are components which may form part of a videoconferencing terminal similar to the terminal 200 of FIGS. 2A and 2B in which case, the videoconferencing terminal would include additional components which are not shown in FIG. 4 for the sake of simplicity.

With reference to FIG. 4, there is shown a plurality of arms 210 configured to be rotated by an actuator (not shown). Some of said arms 210 may be used as display substrate to provide, in operation, the persistence of vision effect as described with respect to FIGS. 2A and 2B. In the example of FIG. 4, four arms 210-1, 210-2, 210-3 and 210-4 are shown from which three arms 210-1, 210-2, 210-3 are configured to be used as display substrates. Arm 210-4 is configured to be used for detection of the position of a touch element 318 of FIG. 3 (for example the finger of a user) as such element 318 touches the substantially transparent substrate. Other numbers of arms and display substrates may also be used.

In the example illustrated in FIG. 4, arms 210-1, 210-2 and 210-3 are configured to operate as display substrates for example by containing light sources generally shown by reference numeral 214. The arms 210-1, 210-2 and 210-3 may further comprise electronics components generally shown by reference numeral 218 configured for driving the light sources 214. The operation of the display substrates of arms 210-1, 210-2 and 210-3 is similar to that described with reference to FIGS. 2A and 2B.

As shown in the example of FIG. 4, arm 210-4 contains capacitive sensors 215 capable of detecting an element touching the substantially transparent substrate 310 as will be described below.

In operation, the motion of the arm 210-4 scans a surface of the substantially transparent substrate 310. The capacitive sensors 215 are configured to perceive an initial electrostatic field intensity when no touch element is touching the substantially transparent substrate 310. Such initial electrostatic field intensity may be of any value, including zero.

In some alternative embodiments, the initial electrostatic field intensity may be zero. This may be the case for example where the substantially transparent substrate is only made of non-conducting material (e.g. glass)

As long as no touch element is touching the substantially transparent substrate 310, the capacitive sensors 215 perceive no change in the initial electrostatic field intensity (any intrinsic change that may occur due to ambient effects or other effects caused by elements other than touch elements are to be either considered negligible or ignored in this description).

Upon touching the substantially transparent substrate 310 with a touch element 318 (FIG. 3) the electrostatic field intensity may change. Indeed, when for example a finger touches the substantially transparent substrate 310, a voltage or a change in voltage, as the case may be, is provided at the position of touching. Therefore, the capacitive sensors 215 detect a change in the electrostatic field intensity at said touching position (or at a proximity thereof) on the substantially transparent substrate 310.

As the capacitive sensors 215 are mounted on the arm 210-4, and due to the movement of the arm 210-4 relative to the substantially transparent substrate, each capacitive sensor is thus capable of scanning a corresponding area on the substantially transparent substrate. In the example of FIG. 4, the arm 210-4 is configured to move in a rotational movement as shown by arrow A. Therefore, in this example each capacitive sensor 215 sweeps a circular coverage area (although with different radii) as the arm 210-4 rotates.

In this manner, when a touch element touches a position on the substantially transparent substrate, that position would correspond to the area scanned by one or more of the capacitive sensors 215. Based on the speed of movement (in this case rotation) of the arm 210-4, and the location of that particular capacitive sensor 215 on the arm 210-4 (for example the radial distance between the capacitive sensor and the center of rotation of the arm), the position of the touch element as it touches the substantially transparent substrate may be determined. Upon associating such position with a specific function or command, a human interface is thus provided which may enable the user to interface with the videoconferencing terminal. For example, the position where the user touches may be a key corresponding to a character on a keyboard and the touch by the user at that position may thus trigger entering a command requiring that corresponding character on a display.

In some embodiments, the determination of the speed of movement of the arm 210-4 may be performed by using an optical source and optical detector pair. In such embodiments, an optical source 320 may be installed on one of the arms 210. In a non-limiting example which will be described below, the optical source and the optical detector may operate using infrared signals.

In operation, the infrared source 320 would move as the arm 210 on which it is installed is moved. For example in FIG. 4, it is assumed that the arms 210 rotate in a circular pattern. In such case, the infrared source 320, installed on arm 210-1, would scan a circular area. An infrared detector 322 installed in the videoconferencing terminal at a predetermined position within the area scanned by the infrared source may be configured to detect the infrared source as the latter passes and establishes optical contact to the infrared detector. A period of time may be measured between two subsequent detections and may thus be used for the calculation of the speed of movement and position of the arm 210-4.

In some embodiments, one or more arms may have one or more light sources and one or more capacitive sensors installed thereon.

In some embodiments, where the movement of the arms is circular, at least two arms are positioned symmetrically around the center of rotation of the arms to maintain weight balance in the overall arms structure.

In some embodiments, a specific touch interface area may be designated on the substantially transparent substrate which may be less than the entire surface area of the substantially transparent substrate. For example the touch interface area may be restricted to the lower half of the substantially transparent substrate. This may help prevent unwanted interference of the user's touching actions with the image acquisition process which would require a clear viewing area for the camera 230.

The capacitive sensors 215 may then be connected to an analog-to-digital front-end so as to convert the detected change in electrostatic field intensity into useful data for transmission to other stages of the videoconferencing terminal. The data output from the read-out electronics 217 may then be transmitted to other stationary electronics as needed. For example, the transmission of such output data may be done using free space (e.g. wirelessly or using an optical link). In particular, a high speed data link, an infrared position detector or an ‘ad hoc’ optical or wireless RF link may be used to transmit the output data. Some techniques of transmission of data in a videoconferencing apparatus are disclosed in U.S. patent application Ser. No. 13/537,295 filed Jun. 29, 2012 the content of which is herewith incorporated by reference in its entirety.

In some embodiments, the infrared source 320 and the infrared detector 322, in addition to serving for detecting position as described above, may be used to transmit the output data to further stages of the videoconferencing terminal.

In the embodiment of FIG. 4, the three arms 210-1, 210-2 and 210-3 may be used to display red, green and blue image data to enable the videoconferencing terminal to produce a broad range of colors by performing suitable combinations of such colors.

The capacitive sensors 215 on the fourth arm 210-4 may be any known sensors suitable for the intended use. For example a capacitive sensor may comprise an electrode located on the arm 210-4 connected to circuits configured to measure capacity. In this regard, the substantially transparent substrate may serve as a non-conductive region and the touch element may serve as a second electrode for such capacitor to be formed.

One advantage of the proposed solution is that a videoconferencing terminal made according the disclosed principles would be less susceptible to noise of interference caused by room lighting and the like. Another advantage is that the proposed solution does not add any substantial complexity in the structure of a videoconferencing terminal, for example of the type described in the above-referenced US 2011/0149012, because as the arms already carry corresponding electronics for the operation of the light sources and the associated elements, the addition of the capacitive sensors would only add minor electronics to it.

Although examples of embodiments have been described related to rotational movement of the arms 210, it is to be noted that the disclosure is not limited to only such type of motion and other types of motion of the display substrate may fall within the scope of the claimed invention. One example of such alternative motion is one causing the display substrate to cover a substantially rectangular viewing area such as the embodiment depicted in FIG. 5B of the above-referenced US 2011/0149012.

Those skilled in the art to which the application relates will appreciate that other and further additions, deletions, substitutions and modifications may be made to the described embodiments. Additional embodiments may include other specific terminal. The described embodiments are to be considered in all respects as only illustrative and not restrictive. In particular, the scope of the invention is indicated by the appended claims rather than by the description and figures herein. All changes that come within the meaning and range of equivalency of the claims are to be embraced within their scope.

What is claimed is:

1. An apparatus, comprising:
an actuator configured to move an arm relative to a substantially transparent substrate, said arm comprising a capacitive sensor configured for detecting a change in an electrostatic field in response to a touch effected on said substantially transparent substrate.

2. The apparatus of claim 1 wherein said touch is effected by a touch element.

3. The apparatus of claim 2 wherein the capacitive sensor is configured to identify a position touched by the touch element.

4. The apparatus of claim 2 wherein the touch element is a human finger or a conductive material configured for use in capacitive sensing.

5. The apparatus of claim 1 wherein at least a second arm is configured to operate as a display substrate for providing persistence of vision effect.

6. The apparatus of claim 1 wherein at least one arm is configured to operate as a display substrate for providing persistence of vision effect and comprises a capacitive sensor configured for detecting a change in an electrostatic field in response to a touch effected on said substantially transparent substrate.

7. The apparatus of claim 1 wherein the capacitive sensor is configured to scan an area on the substantially transparent substrate, said scanning being achievable upon the movement of the arm relative to the transparent substrate.

8. The apparatus of claim 1 further comprising an optical source and optical detector configured for determining a speed of movement of the arm.

9. The apparatus of claim 8 wherein the optical source is installed on an arm of the apparatus and the optical detector is installed at a position within a scan area of the optical source said detector being configured to detect an optical signal generated by the optical source.

10. The apparatus of claim 8 wherein the optical source and the optical detector are configured for transmitting data corresponding to detection of a touch to further stages of the apparatus.

11. The apparatus of claim 8 wherein the optical source and the optical detector are configured to operate using infrared signals

12. The apparatus of claim 1 wherein a touch interface area being less than the entire surface area of the substantially transparent substrate is designated to be touched to cause said change in an electrostatic field in the apparatus.

13. The apparatus of claim 1 wherein further arms are configured for respectively displaying red, green and blue image data to enable production of images in color.

14. The apparatus of claim 2 wherein the capacitive sensor comprises an electrode configured to measure capacity where the substantially transparent substrate is a non-conductive region and the touch element is a second electrode for such capacitor.

15. A method comprising:
moving an arm relative to a substantially transparent substrate;
touching said substantially transparent substrate; and
detecting by a capacitive sensor on said arm, a change in an electrostatic field caused by said touch.

16. The method of claim 15 wherein the capacitive sensor identifies a position touched by the touch element.

17. The method of claim 15 wherein the capacitive sensor scans an area on the substantially transparent substrate by moving the arm relative to the transparent substrate.

18. The method of claim 15 further comprising determining a speed of movement of the arm using an optical source and detector pair.

19. The method of claim 18 wherein the optical detector transmits data corresponding to detection of a touch to further stages of the apparatus.

20. The method of claim 15 comprising determining a position of the touch on the substantially transparent substrate as it touches the substantially transparent substrate using data corresponding to the speed of movement of the arm and the location of said capacitive sensor on the arm.
